(19) United States
(12) Patent Application Publication
(10) Pub. No.: US 2023/0249182 A1
(43) Pub. Date: Aug. 10, 2023

(54) MICROFLUIDIC CHIP DEVICE BASED ON MAGNETIC FIELD-CONTROLLED FLUORESCENTLY-LABELED CELL SORTING METHOD AND USE METHOD

(71) Applicant: NANTONG UNIVERSITY, Nantong City (CN)

(72) Inventors: Yuling QIN, Nantong City (CN); Huanhuan CHEN, Nantong City (CN); Tianzhi MAO, Nantong City (CN); Wenqi HU, Nantong City (CN); Lvyang ZHU, Nantong City (CN); Qu TANG, Nantong City (CN)

(73) Assignee: NANTONG UNIVERSITY, Nantong City (CN)

(21) Appl. No.: 17/929,099

(22) Filed: Sep. 1, 2022

(30) Foreign Application Priority Data
Feb. 10, 2022 (CN) 2022-10125750.6

(51) Int. Cl. B01L 3/00

(52) U.S. Cl. CPC B01L 3/50273; B01L 3/502761; B01L 2200/0652; B01L 2300/0816; B01L 2300/0867

(57) ABSTRACT

A microfluidic chip device based on a magnetic field-controlled fluorescently labeled cell sorting method and a use method are disclosed. The microfluidic chip comprises a sample channel, two sheath fluid channels, a first fluorescence detection area, a second fluorescence detection area, a magnetic field control system, a magnetic field-controlled cell sorting area, a target cell channel, and a waste fluid channel. Based on fluorescence signals labeled on the cells, the FACS system is combined with a magnetic field-controlled sorting system to achieve automated cell sorting, which not only miniaturizes and automates the sorting detection integration, but also has the advantages of easy and economical operation. The device sorts both a large number of cell samples and a small number of cell samples, thus overcoming the defects of a flow cytometer.

### CROSS REFERENCE TO RELATED APPLICATION

This patent application claims priority under 35 U.S.C. §119 to Chinese Patent Application No. 202210125750.6, filed on Feb. 10, 2022, the disclosure of which is incorporated by reference herein in its entirety as part of the present application.

### TECHNICAL FIELD

The present disclosure relates to a microfluidic chip device based on a magnetic field-controlled fluorescently labeled cell sorting method, and a use method, and belongs to the technical field of microfluidic chips.

### BACKGROUND ART

Flow Cytometer is a detection means for quantitative analysis and sorting of single cells or other biological particles at a functional level, with an analysis speed of up to tens of thousands of cells/second and the ability to measure a plurality of parameters from a single cell at the same time. Cell sorting is also one of its important applications. It is capable of imparting an electrical charge to droplets containing specific cells based on the light scattering and fluorescence characteristics of each cell, and integrating a high-voltage electric field downstream. The high-voltage electric field is controlled by the feedback of cell signals, such that the droplets containing cells are deflected by the electric field force and finally collected in the target container. Therefore, the flow cytometer is also called fluorescence-activated cell sorter (FACS). The FACS allows high-purity identification and isolation of cell populations, especially for rare cell populations. Among the various methods for isolating and purifying specific cell populations of known phenotype, FACS stands out for experimental and clinical studies that often require high purity cell populations. However, FACS is not only large and expensive in equipment, but also is high in analysis cost and requires a large number of detection samples in single analysis.

### SUMMARY

The present disclosure provides a microfluidic chip device based on a magnetic field-controlled fluorescently labeled cell sorting method and a use method. Based on fluorescence signals labeled on the cells, the FACS system is combined with a magnetic field-controlled sorting system to achieve automated cell sorting, which not only miniaturizes and automates the sorting detection integration, but also has the advantages of easy and economical operation. The device sorts both a large number of cell samples and a small number of cell samples, thus overcoming the defects of a flow cytometer.

The present disclosure employs the following technical solutions:

A microfluidic chip device based on a magnetic field-controlled fluorescently labeled cell sorting method comprises a sample channel, two sheath fluid channels, a first fluorescence detection area, a second fluorescence detection area, a magnetic field control system, a magnetic field-controlled cell sorting area, a target cell channel, and a waste fluid channel.

The sample channel communicates with the two sheath fluid channels, the sample channel and the two sheath fluid channels are connected in parallel with each other, and the sample channel is located between the two sheath fluid channels. Pipelines for connecting the sample channel and the two sheath fluid channels are a first flow channel and a second flow channel respectively. The first flow channel and the second flow channel intersect with the two sheath fluid channels at a first intersection point and a second intersection point respectively. The target cell channel starts from the first intersection point, and the waste fluid starts from the second intersection point. The magnetic field-controlled cell sorting area is provided on the first flow channel and the second flow channel, and the cell sorting area comprises one magneton. The magneton is controlled by the magnetic field control system to move back and forth on the first flow channel and the second flow channel so as to control a flow direction of a sample. When the magneton is located at the first flow channel, the sample channel communicates with the waste fluid channel, and when the magneton is located at the second flow channel, the sample channel communicates with the target cell channel.

The first fluorescence detection area is located on the sample channel; and the second fluorescence detection area is located on the target cell channel.

A sample inlet of the sample channel and sample inlets of the two sheath fluid channels are connected to an injector and corresponding injection pumps respectively to provide power for the solution to flow in the chip.

A sample outlet of the waste fluid channel is connected to a special collection bottle for waste fluid, which is used for collecting cells not required for sorting as well as excess cell waste fluid.

A sample outlet of the target cell channel is connected to a special bottle for target cells, which is used for collecting a solution containing target cells.

Further, the injector connected to the sample inlet of the sample channel is filled with a pre-treated cell sample solution. The injectors connected to the sample inlets of the two sheath fluid channels are filled with a corresponding sheath solution, cell buffer or culture solution.

Further, the first fluorescence detection area and the second fluorescence area have the same structure, each comprising a laser device and a fluorescence detector. The laser device and the fluorescence detector are respectively located at two sides of the chip; and the fluorescence detector comprises an optical filter.

Further, the optical filter may filter out a non-fluorescence signal, and only the fluorescence is retained to enter the detector.

Further, the first flow channel and the second flow channel are respectively provided with a limit groove at the first intersection point and the second intersection point for enabling the magneton to block a path to the target cell channel or the waste fluid channel.

Further, the chip device is made of a plastic material with chemical inertness, optical transparence, and biocompatibility.

Further, the material of the chip device comprises polydimethylsiloxane, polymethyl methacrylate (PMMA), cyclic olefin copolymer (COC), and cyclic olefin polymer (COP), etc.

A method for sorting fluorescently labeled cells by the microfluidic chip device based on the magnetic field-controlled fluorescently labeled cell sorting method comprises the following steps:
S1, during preparation of sample injection, the laser devices, the fluorescence detectors and the magnetic field control system are turned on, and then three sample injection pumps are enabled;
S2; during sample injection, a solution injected into the sample inlet of the sample channel is a pre-treated cell sample solution incubated by a fluorescence antibody, and a solution injected into the sample inlet of each sheath fluid channel is a sheath fluid solution;
S3, when the pre-treated sample solution flows through the first fluorescence detection area and the second fluorescence detection area, the laser and the fluorescence detector may detect the solution in sequence, a detection result is processed by a computer system and then fed back to the magnetic field control system controlled by the computer system, and the magnetic field control system may control a movement direction of the magneton in the magnetic field;
S31, if no cell with a fluorescently-labelled signal is detected in the first fluorescence detection area, the magnetic field control system may control the magneton to move to the first flow channels to block a path to the target cell channel, thus enabling the sample solution to flow towards the sample outlet of the waste fluid channel and to be collected in the special bottle for waste fluid finally;
S32, if the cell with the fluorescently-labeled signal is detected in the first fluorescence detection area, the magnetic field control system may control the magneton to move to the second flow channel to block a path to the waste fluid channel, thus enabling the sample solution containing the target cells to flow towards the sample outlet of the target cell channel and to flow through the second fluorescence detection area to reconfirm whether the target cell detected by the first fluorescence detection area exists or not, if it is reconfirmed that the target cell is detected, the system controls the magneton to return to the first flow channel to block the path to the target cell channel;
S33, repeating the step S31 and the step S32, and finally performing collection in the special bottle for target cells to obtain the target cells.

The present disclosure has the beneficial effects that:

(1) Compared with the traditional flow fluorescence cell sorting means, the device not only miniaturizes and automates the sorting detection integration, but also has the advantages of easy and economical operation.

(2) The device is not controlled by the cell sample size, which may be both large and small samples.

(3) After the sample is pretreated, all operations are carried out in the chip, with less pollution.

(4) The cell sorting occurs inside the pipeline of the chip, with a higher sorting accuracy.

### BRIEF DESCRIPTION OF THE DRAWINGS

FIG. 1 is a design diagram of a three-dimensional structure of the device.

FIGS. 2A and 2B provide a structure diagram of a cell sorting area; FIG. 2A illustrates a situation that no fluorescence signal is detected in the first fluorescence detection area at an upper stream of the cell sorting area; FIG. 2B illustrates a situation that a fluorescence signal is detected in the first fluorescence detection area at an upper stream of the cell sorting area.

FIG. 3 is a diagram of a distribution structure of a fluorescence detection area.

FIG. 4 is a side view of a fluorescence detection area.

In the drawings: 100-magnetic field-controlled fluorescently labeled cell sorting method; 102-sample channel; 104a-sheath fluid channel; 104b-sheath fluid channel; 106-first fluorescence detection area; 108-second fluorescence detection area; 110-magnetic field control system; 112-magnetic field-controlled cell sorting area; 114-target cell channel; 116-waste fluid channel; 118-first intersection point; 120-second intersection point; 122-magneton; 130-laser device; 132-fluorescence detector; 134-chip; 136-optical filter; 138-laser; 140-sample inlet of sample channel; 142a-sample inlet of sheath fluid channel; 142b-sample inlet of sheath fluid channel; 144-sample outlet of waste fluid channel; 146-sample outlet of target cell channel.

### DETAILED DESCRIPTION OF THE EMBODIMENTS

The following describes the embodiments of the present disclosure in detail, and examples of the embodiments are illustrated in the accompanying drawings. The embodiments described below with reference to the accompanying drawings are exemplary, and are intended only to explain the present disclosure, and cannot be construed as limiting the present disclosure.

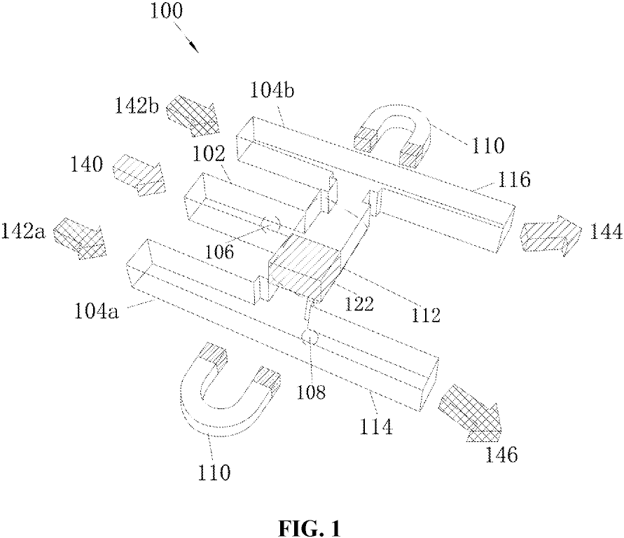

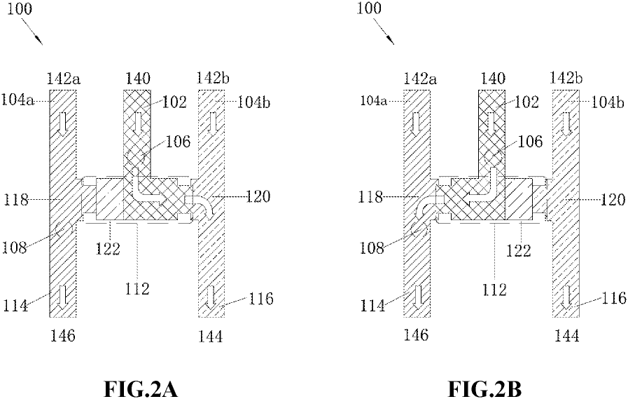

As shown in FIG. 1 and FIGS. 2A and 2B, a microfluidic chip device based on a magnetic field-controlled fluorescently labeled cell sorting method 100 comprises a sample channel 102, two sheath fluid channels 104a, 104b, a first fluorescence detection area 106, a second fluorescence detection area 108, a magnetic field control system 110, a magnetic field-controlled cell sorting area 112, a target cell channel 114, and a waste fluid channel 116. The chip device is made of a plastic material with chemical inertness, optical transparence, and biocompatibility. The material of the chip device comprises polydimethylsiloxane, PMMA, COC, and COP, etc.

The sample channel 102 communicates with the two sheath fluid channels 104a, 104b, the sample channel 102, and the two sheath fluid channels 104a, 104b are connected in parallel with each other, and the sample channel 102 is located between the two sheath fluid channels 104a, 104b. Pipelines for connecting the sample channel 102 and the two sheath fluid channels 104a, 104b are a first flow channel and a second flow channel respectively. The first flow channel and the second flow channel intersect with the two sheath fluid channels 104a, 104b at a first intersection point 118 and a second intersection point 120 respectively. The target cell channel 114 starts from the first intersection point 118, and the waste fluid starts from the second intersection point 120. The magnetic field-controlled cell sorting area 112 is provided on the first flow channel and the second flow channel, and the cell sorting area comprises one magneton 122. The magneton 122 is controlled by the magnetic field control system 110 to move back and forth on the first flow channel and the second flow channel so as to control a flow direction of a sample. When the magneton 122 is located at the first flow channel, the sample channel communicates with the waste fluid channel, and when the magneton 122 is located at the second flow channel, the sample channel 102 communicates with the target cell channel 114. The first flow channel and the second flow channel are respectively provided with a limit groove at the first intersection point 118 and the second intersection point 120 for enabling the magneton 122 to block a path to the target cell or the waste fluid channel 116.

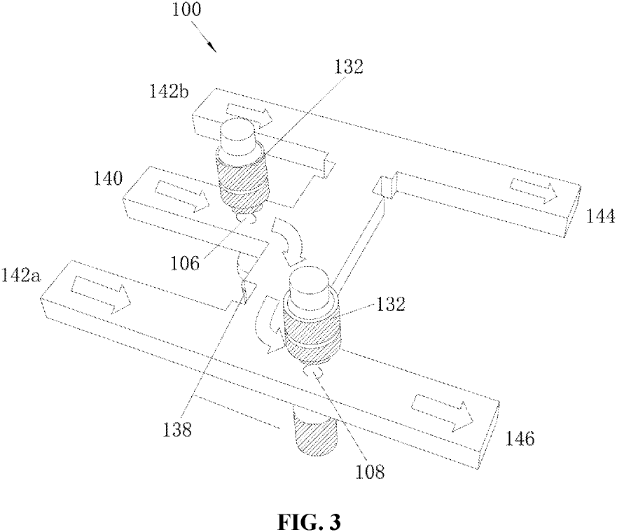

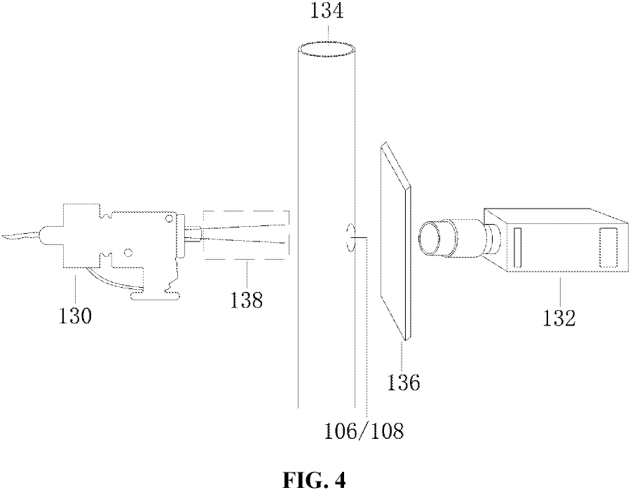

As shown in FIG. 3 and FIG. 4, the first fluorescence detection area 106 is located on the sample channel 102; and the second fluorescence detection area 108 is located on the target cell channel 114. The first fluorescence detection area 106 and the second fluorescence area 108 have the same structure, each comprising a laser device 130 and a fluorescence detector 132, wherein the laser device 130 and the fluorescence detector 132 are respectively located at two sides of the chip 134; and each fluorescence detector 132 contains an optical filter. A laser 138 located below the fluorescence detection area (106, 108) emits a laser source (a dotted block) to continuously irradiate on the fluorescence detection area (106, 108), thus making an optical signal pass through the optical filter 136 and the laser detector above the fluorescence detection area. When a fluorescence signal exists in the fluorescence detection area (106, 108), the optical filter 136 may filter out the non-fluorescence signal, making the laser detector only capture the fluorescence signal. When no fluorescence signal exists in the fluorescence detection area (106, 108), no signal is counted in the detector after the laser irradiates the fluorescence detection area and filtered by the optical filter 136.

A sample inlet 140 of the sample channel 102 and sample inlets 142a, 142b of the two sheath fluid channels 104a, 104b are connected to an injector and corresponding injection pumps respectively to provide power for a solution to flow in the chip 134. A sample outlet 144 of the waste fluid channel 116 is connected to a special collection bottle for waste fluid, which is used for collecting cells not required for sorting as well as excess cell waste fluid. A sample outlet 146 of the target cell channel 114 is connected to a special bottle for target cells, which is used for collecting a solution containing the target cells.

A method for sorting fluorescently labeled cells by the microfluidic chip device based on the magnetic field-controlled fluorescently labeled cell sorting method comprises the following steps:

S1, during preparation of sample injection, the laser devices, the fluorescence detectors and the magnetic field control system are turned on, and then three sample injection pumps are enabled;

S2, during sample injection, a solution injected into the sample inlet of the sample channel is a pre-treated cell sample solution incubated by a fluorescence antibody, and a solution injected into the sample inlet of each sheath fluid channel is a sheath fluid solution;

S3, when the pre-treated sample solution flows through the first fluorescence detection area and the second fluorescence detection area, the laser and the fluorescence detector may detect the solution in sequence, a detection result is processed by a computer system and then fed back to the magnetic field control system controlled by the computer system, and the magnetic field control system may control a movement direction of the magneton in the magnetic field;

S31, if the first fluorescence detection area does not detect a cell with a fluorescently-labelled signal, the magnetic field control system may control the magneton to move to the first flow channels to block a path to the target cell channel, thus enabling the sample solution to flow towards the sample outlet of the waste fluid channel and to be collected in the special bottle for waste fluid finally;

S32, if the first fluorescence detection area detects the cell with the fluorescently-labeled signal, the magnetic field control system may control the magneton to move to the second flow channel to block a path to the waste fluid channel, thus enabling the sample solution containing the target cells to flow towards the sample outlet of the target cell channel and to flow through the second fluorescence detection area to reconfirm whether the target cell detected by the first fluorescence detection area exists or not, if it is reconfirmed that the target cell is detected, the system controls the magneton to return to the first flow channel to block the path to the target cell channel; and

S33, repeating the step S31 and the step S32, and performing collection in the special bottle for target cells to obtain the target cells.

What is claimed is:

1. A microfluidic chip device based on a magnetic field-controlled fluorescently labeled cell sorting method, wherein the microfluidic chip comprises a sample channel, two sheath fluid channels, a first fluorescence detection area, a second fluorescence detection area, a magnetic field control system, a magnetic field-controlled cell sorting area, a target cell channel, and a waste fluid channel;
wherein the sample channel communicates with the two sheath fluid channels, the sample channel and the two sheath fluid channels are connected in parallel with each other, and the sample channel is located between the two sheath fluid channels; pipelines for connecting the sample channel and the two sheath fluid channels are a first flow channel and a second flow channel respectively; the first flow channel and the second flow channel intersect with the two sheath fluid channels at a first intersection point and a second intersection point respectively; the target cell channel starts from the first intersection point, and the waste fluid starts from the second intersection point;
the magnetic field-controlled cell sorting area is provided on the first flow channel and the second flow channel, and the cell sorting area comprises one magneton; the magneton is controlled by the magnetic field control system to move back and forth on the first flow channel and the second flow channel so as to control a flow direction of a sample; when the magneton is located at the first flow channel, the sample channel communicates with the waste fluid channel, and when the magneton is located at the second flow channel, the sample channel communicates with the target cell channel;
the first fluorescence detection area is located on the sample channel; and the second fluorescence detection area is located on the target cell channel;
a sample inlet of the sample channel and sample inlets of the two sheath fluid channels are connected to an injector and corresponding injection pumps respectively to provide power for a solution to flow in the chip;
a sample outlet of the waste fluid channel is connected to a special collection bottle for waste fluid, which is used for collecting cells not required for sorting as well as excess cell waste fluid;
a sample outlet of the target cell channel is connected to a special bottle for target cells, which is used for collecting a solution containing the target cells.

2. The device according to claim 1, wherein the injector connected to the sample inlet of the sample channel is filled with a pre-treated cell sample solution; the injectors connected to the sample inlets of the two sheath fluid channels are filled with a corresponding sheath solution, cell buffer or culture solution.

3. The device according to claim 1, wherein the first fluorescence detection area and the second fluorescence area have the same structure, each comprising a laser device and a fluorescence detector, wherein the laser device and the fluorescence detector are respectively located at two sides of the chip; and the fluorescence detector comprises an optical filter.

4. The device according to claim 3, wherein the optical filter is able to filter out non-fluorescence signals, and only the fluorescence is retained to enter the detector.

5. The device according to claim 1, wherein the first flow channel and the second flow channel are respectively provided with a limit groove at the first intersection point and the second intersection point for enabling the magneton to block a path to the target cell channel or the waste fluid channel.

6. The device according to claim 1, wherein the chip device is made of a plastic material with chemical inertness, optical transparence, and biocompatibility.

7. The device according to claim 6, wherein the material of the chip device comprises polydimethylsiloxane, PMMA, COC, and COP, etc.

8. A method for sorting fluorescently labeled cells by the microfluidic chip device based on the magnetic field-controlled fluorescently labeled cell sorting method according to claim 1, comprising the following steps:
S1, during preparation of sample injection, the laser devices, the fluorescence detectors and the magnetic field control system are turned on, and then three sample injection pumps are enabled;
S2; during sample injection, a solution injected into the sample inlet of the sample channel is a pre-treated cell sample solution incubated by a fluorescence antibody, and a solution injected into the sample inlet of each sheath fluid channel is a sheath fluid solution;
S3, when the pre-treated sample solution flows through the first fluorescence detection area and the second fluorescence detection area, the laser and the fluorescence detector are able to detect the solution in sequence, a detection result is processed by a computer system and then fed back to the magnetic field control system controlled by the computer system, and the magnetic field control system is able to control a movement direction of the magneton in the magnetic field;
S31, if no cell with a fluorescently-labelled signal is detected in the first fluorescence detection area, the magnetic field control system is able to control the magneton to move to the first flow channels to block a path to the target cell channel, thus enabling the sample solution to flow towards the sample outlet of the waste fluid channel and to be collected in the special bottle for waste fluid finally;
S32, if the cell with the fluorescently-labeled signal is detected in the first fluorescence detection area, the magnetic field control system is able to control the magneton to move to the second flow channel to block a path to the waste fluid channel, thus enabling the sample solution containing the target cells to flow towards the sample outlet of the target cell channel and to flow through the second fluorescence detection area to reconfirm whether the target cell detected by the first fluorescence detection area exists or not, if it is reconfirmed that the target cell is detected, the system controls the magneton to return to the first flow channel to block the path to the target cell channel; and
S33, repeating the step S31 and the step S32, and finally performing collection in the special bottle for target cells to obtain the target cells.

9. The method according to claim 8, wherein the injector connected to the sample inlet of the sample channel is filled with a pre-treated cell sample solution; the injectors connected to the sample inlets of the two sheath fluid channels are filled with a corresponding sheath solution, cell buffer or culture solution.

10. The method according to claim 8, wherein the first fluorescence detection area and the second fluorescence area have the same structure, each comprising a laser device and a fluorescence detector, wherein the laser device and the fluorescence detectors are respectively located at two sides of the chip; and the fluorescence detector comprises an optical filter.

11. The method according to claim 10, wherein the optical filter is able to filter out non-fluorescence signals, and only the fluorescence is retained to enter the detector.

12. The method according to claim 8, wherein the first flow channel and the second flow channel are respectively provided with a limit groove at the first intersection point and the second intersection point for enabling the magneton to block a path to the target cell channel or the waste fluid channel.

13. The method according to claim 8, wherein the chip device is made of a plastic material with chemical inertness, optical transparence, and biocompatibility.

14. The method according to claim 13, wherein the material of the chip device comprises polydimethylsiloxane, PMMA, COC, and COP, etc.
